(19) United States
(12) Patent Application Publication
(10) Pub. No.: US 2019/0351721 A1
(43) Pub. Date: Nov. 21, 2019

(54) TRAILER HITCH INTEGRATED TOW HOOK AND STEP

(71) Applicant: GM GLOBAL TECHNOLOGY OPERATIONS LLC, DETROIT, MI (US)

(72) Inventors: Gary A. Klein, Royal Oak (US); Darren L. Bohne, Clarkston (US); Todd R. Hubbard, Farmington, MI (US); Bradford G. Schreiber, Clarkston, MI (US); David Kennedy, Farmington Hills, MI (US)

(21) Appl. No.: 15/979,957

(22) Filed: May 15, 2018

(51) Int. Cl. B60D 1/54

(52) U.S. Cl. CPC B60D 1/54; B60D 1/18; B60D 2001/544

(57) ABSTRACT

An exemplary tow hook assembly for a vehicle includes a tow hook, a bracket, and a coupling member. The tow hook is coupled to the bracket by the coupling member. The tow hook is pivotable between a first position and a second position about the coupling member. In the second position, the tow hook is contained within a horizontal dimension and a vertical dimension defined by the bumper.

### INTRODUCTION

The present invention relates generally to the field of vehicles and, more specifically, to a trailer hitch integrated hinged tow hook.

Some vehicles are equipped with a hitch assembly that allows for the towing of different types of objects mounted on a trailer, such as a boat, a recreation vehicle, and/or equipment. Generally, the hitch assembly is mounted to the frame of the towing vehicle. In some arrangements, the hitch assembly includes a tow hook. However, the location of the tow hook can be obstructed by the vehicle's rear lift gate or may extend below the vehicle such that the vehicle's ground clearance is reduced.

Additionally, some vehicles include bumper corner steps integrally molded into the vehicle bumper. These bumper corner steps permanently extend below the vehicle bumper and can restrict use of the vehicle in offroad driving or other situations in which the vehicle encounters obstacles requiring clearance. Furthermore, for vehicles equipped with a suspension lift or other raised suspension, access to the truck bed and/or roof may be difficult without a step or other feature.

### SUMMARY

Embodiments according to the present disclosure provide a number of advantages. For example, embodiments according to the present disclosure provide an additional towing connection point and step at a vehicle corner to improve user access to a vehicle bed or roof, for example and without limitation. Additionally, embodiments according to the present disclosure fit within an opening defined by the vehicle bumper such that vehicle ground clearance is not reduced in the path of the vehicle tire.

In one aspect, a tow hook assembly for a vehicle includes a tow hook, a bracket, and a coupling member. The tow hook includes a first arm having a first end and a second end opposite the first end, the first end defining a first opening; a second arm having a first end and a second end opposite the first end, the first end defining a second opening; and a connecting portion having a first end and a second end, the second end of the first arm extending from the first end of the connecting portion and the second end of the second arm extending from the second end of the connecting portion, the first arm, the second arm, and the connecting portion forming a U-shaped member. The bracket includes a first leg having a first end and a second end opposite the first end, the first end defining a first opening; a second leg having a first end and a second end opposite the first end, the first end defining a second opening; and a body portion having a first side and a second side, the second end of the first leg extending from the first side of the body portion and the second end of the second leg extending from the second side of the body portion. The coupling member passes through the first and second openings of the first and second arms of the tow hook and the first and second openings of the first and second legs of the bracket such that the tow hook is pivotable between a first position and a second position relative to the bracket.

In some aspects, the bracket further includes a stop portion extending from the body portion and the stop portion limits rotation of the tow hook relative to the bracket.

In some aspects, the bracket further includes a first stop portion and a second stop portion, the first stop portion extending from the first side of the body portion and the second stop portion extending from the second side of the body portion, the first stop portion adjacent to the first arm of the tow hook and the second stop portion adjacent to the second arm of the tow hook such that the first and second stop portions limit rotation of the tow hook relative to the bracket.

In some aspects, the coupling member is a bolt.

In some aspects, the first position is a stowed position and the second position is an extended position.

In another aspect, an automotive vehicle includes a vehicle body, the vehicle body includes a bumper including a bumper shell, an edge of the bumper shell defining an underbody opening; a trailer hitch assembly, the trailer hitch assembly includes a mounting member; and a tow hook assembly coupled to the mounting member of the trailer hitch assembly, the tow hook assembly includes a tow hook, a bracket, and a coupling member, the tow hook coupled to the bracket by the coupling member, the tow hook pivotable between a first position and a second position about the coupling member. The tow hook is contained within a horizontal dimension and a vertical dimension defined by the bumper when the tow hook is in both the first and the second positions.

In some aspects, the tow hook is positioned within the underbody opening such that the tow hook does not extend beyond the bumper shell in either a vertical or a horizontal direction.

In some aspects, the bracket includes a body portion, a first leg, and a second leg, the first leg extending from a first side of the body portion and the second leg extending from a second side of the body portion opposite the first side such that the first leg and the second leg are substantially parallel.

In some aspects, the tow hook includes a first arm, a second arm, and a connecting portion, the first arm extending from a first end of the connecting portion and the second leg extending from a second end of the connecting portion opposite the first end such that the first arm and the second arm are substantially parallel.

In some aspects, the bracket further includes at least one stop portion extending from the body portion, wherein the stop portion limits rotation of the tow hook relative to the bracket.

In some aspects, the first position is a stowed position and the second position is an extended position.

In yet another aspect, a tow hook assembly for a vehicle includes a tow hook, a bracket, and a coupling member, the tow hook coupled to the bracket by the coupling member, the tow hook pivotable between a first position and a second position about the coupling member. The tow hook is contained within a horizontal dimension and a vertical dimension defined by the bumper when the tow hook is in both the first and the second positions.

In some aspects, the tow hook further includes a first arm and a second arm and a connecting portion connecting the first arm and the second arm such that the tow hook forms a U-shaped member.

In some aspects, the bracket further includes a body portion and a first leg and a second leg, the first leg and the second leg extending from opposite sides of the body portion.

In some aspects, the bracket further includes a stop portion extending from the body portion and the stop portion limits rotation of the tow hook relative to the bracket.

In some aspects, the bracket further includes a first stop portion and a second stop portion, the first stop portion extending from a first side of the body portion and the second stop portion extending from a second side of the body portion, the first stop portion adjacent to the first arm of the tow hook and the second stop portion adjacent to the second arm of the tow hook, the first and second stop portions limiting rotation of the tow hook relative to the bracket.

In some aspects, the coupling member is a bolt.

In some aspects, the first position is a stowed position and the second position is an extended position.

### BRIEF DESCRIPTION OF THE DRAWINGS

The present disclosure will be described in conjunction with the following figures, wherein like numerals denote like elements.

FIG. 1 is a partial perspective side view of a vehicle having a trailer hitch integrated tow hook, according to an embodiment.

FIG. 2 is a partial perspective side view of the vehicle of FIG. 1 with the tow hook in an extended position, according to an embodiment.

FIG. 3 is a partial underside view of the vehicle of FIG. 1, according to an embodiment.

FIG. 4 is a partial side view of the vehicle of FIG. 1, illustrating the tow hook in a stowed position.

FIG. 5 is a partial side view of the vehicle of FIG. 1, illustrating the tow hook in an extended position.

The foregoing and other features of the present disclosure will become more fully apparent from the following description and appended claims, taken in conjunction with the accompanying drawings. Understanding that these drawings depict only several embodiments in accordance with the disclosure and are not to be considered limiting of its scope, the disclosure will be described with additional specificity and detail through the use of the accompanying drawings. Any dimensions disclosed in the drawings or elsewhere herein are for the purpose of illustration only.

### DETAILED DESCRIPTION

Embodiments of the present disclosure are described herein. It is to be understood, however, that the disclosed embodiments are merely examples and other embodiments can take various and alternative forms. The figures are not necessarily to scale; some features could be exaggerated or minimized to show details of particular components. Therefore, specific structural and functional details disclosed herein are not to be interpreted as limiting, but merely as a representative basis for teaching one skilled in the art to variously employ the present invention. As those of ordinary skill in the art will understand, various features illustrated and described with reference to any one of the figures can be combined with features illustrated in one or more other figures to produce embodiments that are not explicitly illustrated or described. The combinations of features illustrated provide representative embodiments for typical applications. Various combinations and modifications of the features consistent with the teachings of this disclosure, however, could be desired for particular applications or implementations.

Certain terminology may be used in the following description for the purpose of reference only, and thus are not intended to be limiting. For example, terms such as “above” and “below” refer to directions in the drawings to Which reference is made. Terms such as “front,” “back,” “left,” “right,” “rear,” and “side” describe the orientation and/or location of portions of the components or elements within a consistent but arbitrary frame of reference which is made clear by reference to the text and the associated drawings describing the components or elements under discussion. Moreover, terms such as “first,” “second,” “third,” and so on may be used to describe separate components. Such terminology may include the words specifically mentioned above, derivatives thereof, and words of similar import.

To provide access to the vehicle truck bed and/or roof, embodiments discussed herein relate to a pivotable tow hook and step integrated with the existing vehicle trailer hitch mounting structure. The pivotable structure allows the tow hook to fold up within the space enclosed by the bumper such that vehicle clearance is not affected. Furthermore, the pivotable tow hook provides an additional rigid protective member to one or more corners of the vehicle bumper.

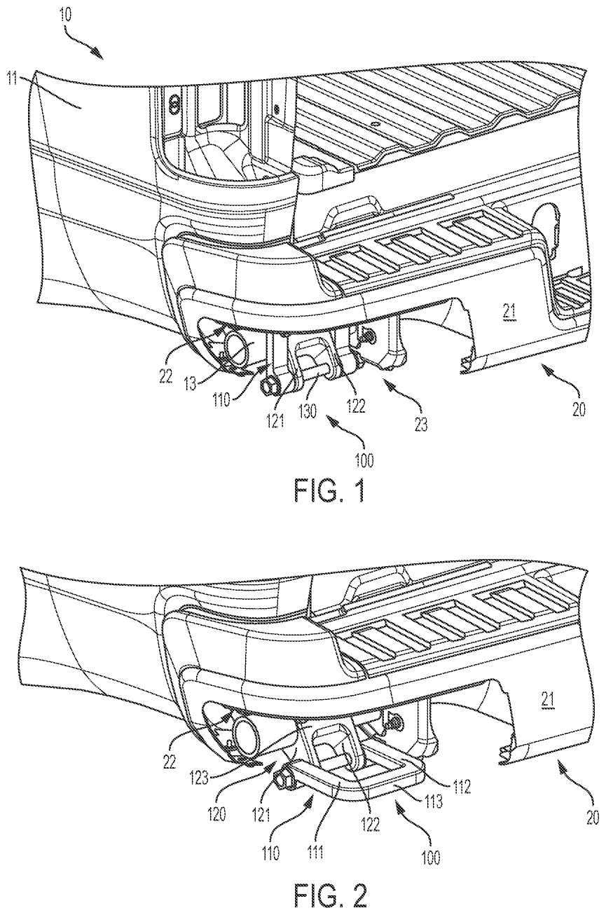

FIGS. 1-5 illustrate a tow hook assembly 100 for a vehicle 10, according to an embodiment. The vehicle 10 includes a body 11 and a bumper 20. The body 11 is arranged on a chassis (not shown) and substantially encloses the other components of the vehicle 10. The bumper 20 includes a bumper shell 21 that forms a visible outer skin of the vehicle and is designed to absorb and yield to the energy transfer of an impact event. In some embodiments, the bumper shell 21 wraps around the side of the vehicle 10 (as shown in FIGS. 1 and 2). In some embodiments, an edge 22 in the bumper shell 21 defines an underbody opening 23 at each corner of the bumper 20. In some embodiments, such as the embodiments shown in FIGS. 1-5, the opening 23 provides access to a trailer hitch assembly of the vehicle 10.

The tow hook assembly 100 is, in some embodiments, integrated into or coupled to the trailer hitch assembly of the vehicle 10. In some embodiments, the trailer hitch assembly includes a mounting member 12, a mounting extension member 13, and a trailer hitch 14. In some embodiments, the mounting extension member 13 extends longitudinally from the mounting member 12 to extend the trailer hitch mounting structure toward the side corners of the vehicle 10. In some embodiments, the mounting member 12 and/or the mounting extension member 13 are tubular structures extending from one side of the vehicle 10 to the other at least partially within an opening 23 in the underside of the vehicle 10 defined by the bumper 20. In some embodiments, the mounting member 12 and the mounting extension member 13 are integrally formed. In some embodiments, the mounting member 12 and the mounting extension member 13 are separate pieces joined together by any mechanical or chemical means known to those skilled in the art. The trailer hitch 14 extends outward from the rear of the vehicle (as shown in FIGS. 4 and 5) for attachment of a towed vehicle or trailer.

In some embodiments, the tow hook assembly 100 includes a tow hook 110 pivotably coupled to a bracket 120 by a coupling member 130. In some embodiments, the bracket 120 is coupled to the trailer hitch mounting extension member 13. In some embodiments, the bracket 120 is integrally formed with the mounting extension member 13. In some embodiments, the bracket 120 is mechanically (via any type of mechanical fastener, such as bolts or screws) or chemically (via welding) coupled to the mounting extension member 13. In some embodiments, the coupling member 130 is a bolt.

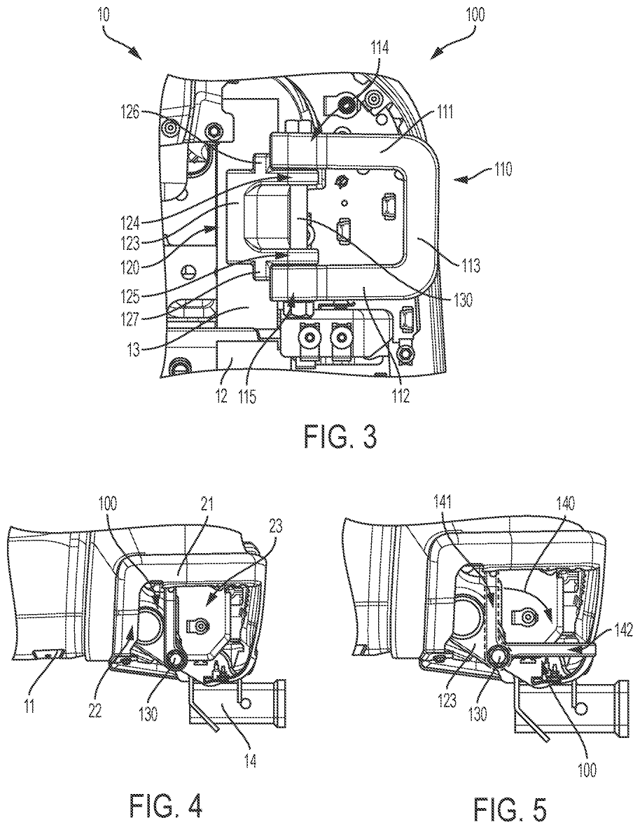

With continued reference to FIGS. 1-5, the tow hook 110 is a pivotable structure coupled to the bracket 120 via the coupling member 130 such that the tow hook 110 can pivot about an axis defined by the coupling member 130. The tow hook 110 includes a first arm 111 and a second arm 112. The first arm 111 and the second arm 112 are coupled to the coupling member 130. A connecting portion 113 connects the first arm 111 and the second arm 112. The first arm 111 extends from a first end of the connecting portion 113 and the second arm 112 extends from a second end of the connecting portion opposite the first end such that the first arm 111 and the second arm 112 are substantially parallel such that, in some embodiments, the tow hook 110 is substantially U-shaped. Each of the first and second arms 111, 112 include an opening configured to receive the coupling member 130. The openings in each of the first and second arms (indicated by arrows 114, 115 on FIG. 3) extend through the first and second arms 111, 112 such that the coupling member 130 passes through the openings 114, 115. The openings 114, 115 extend through the first and second arms 111, 112 through the upper end of the U-shape such that the coupling member 130 extends through the upper end of the U-shaped tow hook 110 opposite the connecting portion 113.

In some embodiments, the bracket 120 includes a first leg 121 and a second leg 122 extending from a body portion 123. The first leg 121 extends from a first side of the body portion 123 and the second leg 122 extends from a second side of the body portion 123 opposite the first side such that the first leg 121 and the second leg 122 are substantially parallel. Each of the first and second legs 121, 122 include an opening configured to receive the coupling member 130. The openings in each of the first and second legs (indicated by arrows 124, 125 on FIG. 3) extend through the first and second legs 121, 122 such that the coupling member 130 passes through the openings 124, 125 and is oriented substantially parallel to the body portion 123 of the bracket 120.

In some embodiments, the bracket 120 includes one or more stop portions. With reference to FIG. 3, the bracket 120 includes a first stop portion 126 and a second stop portion 127. The first stop portion 126 extends from the first side of the body portion 123 and the second stop portion extends from the second side of the body portion 123. The first stop portion 126 extends from the body portion 123 adjacent to a terminal end of the first arm 111 of the tow hook 110. Similarly, the second stop portion 127 extends from the body portion 123 adjacent to a terminal end of the second arm 112 of the tow hook 110.

In some embodiments, the first and second arms 111, 112 of the tow hook 110 couple to the coupling member 130 outside of the first and second legs 121, 122 of the bracket 120. However, in other embodiments, the orientation of the connection of the first and second arms 111, 112 and the first and second legs 121, 122 to the coupling member 130 may be reversed.

As best illustrated in FIGS. 4 and 5, the tow hook 110 rotates from a first or stowed, position, indicated by arrow 141, to and from a second, or extended position, indicated by arrow 142. As shown in FIG. 5, the arrow 140 indicates the direction of rotation from the first position to the second position. In some embodiments, the tow hook 110 rotates about the coupling member 130 passing through the terminal end of the first arm 111 and the terminal end of the second arm 112 from the first position to the second position and vice versa. In some embodiments, a compressive member, such as a spring (not shown), maintains the tow hook 110 in the first position until an operator manually rotates the tow hook 110 into the second position. In some embodiments, rotational friction between the openings 114, 115 in the tow hook 110 and the bolt 130 maintain the tow hook 110 in either or both of the first position or the second position.

The first and second stop portions 126, 127 limit rotation of the tow hook 110. In some embodiments, contact between the terminal end of the first arm 111 and the first stop portion 126 and contact between the terminal end of the second arm 112 and the second stop portion 127 prevents further downward rotation (that is, rotation in the clockwise direction indicated by arrow 140) of the tow hook 110. In other words, as the tow hook 110 rotates in a clockward direction (that is, rotates from the first position to the second position), the terminal ends of the first and second arms 111, 112 contact the stop portions 126, 127 which limit further rotation of the tow hook 110 and, in some embodiments, support the tow hook 110 in the second position. In some embodiments, a stop portion may be located adjacent to one or both of the terminal ends of the first and second arms 111, 112.

In some embodiments, the tow hook 110 is contained within and does not extend outside the opening 23 defined by the edge 22 in the bumper shell 21 when the tow hook 110 is in either of the first or second positions. In other words, in some embodiments, the tow hook 110 is within the dimensions defined by the bumper 20 when the tow hook 110 is in both the stowed and extended positions. In either the first or second positions, the tow hook 110 does not extend below the mounting member 12 and thus does not reduce vehicle underbody clearance. The edge 22 defines the opening 23 such that the connecting portion 113 of the tow hook 110 may be used as a step.

It will be appreciated that the vehicle 10 may be implemented as any one or more of a number of different types of vehicles. For example, the vehicle 10 may be any one of a number of different types of automobiles and/or other vehicle types. For example, in various embodiments, the vehicle 10 may be a sedan, a wagon, a truck, or a sport utility vehicle (SUV), and may be two-wheel drive (2WD) (i.e., rear-wheel drive or front-wheel drive), four-wheel drive (4WD) or all-wheel drive (AWD), and/or any one of a number of other types of vehicles.

Additionally, while illustrated as a rectangular structure, the tow hook 110 may take any other shape, such as square, semicircular, etc. that is pivotable with respect to the trailer hitch structure of the vehicle and provides functionality as both a tow hook and a step.

In some embodiments, when the tow hook 110 is rotated to the extended position, a user can place a foot on the connecting portion 113, using the tow hook 110 as a step to allow the user improved access to the vehicle bed and/or roof. The stop portions 126, 127 limit further downward rotation of the tow hook 110 and support the tow hook 110 in the extended position such that the user's weight is supported when the tow hook 110 is used as a step. Additionally, in some embodiments, when the tow hook 110 is in the extended position, a recovery strap or other towing cable can be attached to the tow hook for use as a traditional tow hook to tow a trailer, for example and without limitation. In both the extended position and the stowed position, the tow hook assembly 100 fits within the horizontal and vertical dimensions defined by the bumper such that the tow hook assembly does not reduce vehicle ground clearance in the path of the tire.

In some embodiments, the tow hook 110 is manually adjusted between the first position and the second position. In some embodiments, an actuator (not shown) may be controlled by a vehicle controller (not shown) to adjust the position of the tow hook 110.

It should be emphasized that many variations and modifications may be made to the herein-described embodiments, the elements of which are to be understood as being among other acceptable examples. All such modifications and variations are intended to be included herein within the scope of this disclosure and protected by the following claims. Moreover, any of the steps described herein can be performed simultaneously or in an order different from the steps as ordered herein. Moreover, as should be apparent, the features and attributes of the specific embodiments disclosed herein may be combined in different ways to form additional embodiments, all of which fall within the scope of the present disclosure.

Conditional language used herein, such as, among others, “can,” “could,” “might,” “may,” “e.g.,” and the like, unless specifically stated otherwise, or otherwise understood within the context as used, is generally intended to convey that certain embodiments include, while other embodiments do not include, certain features, elements and/or states. Thus, such conditional language is not generally intended to imply that features, elements and/or states are in any way required for one or more embodiments or that one or more embodiments necessarily include logic for deciding, with or without author input or prompting, whether these features, elements and/or states are included or are to be performed in any particular embodiment.

Moreover, the following terminology may have been used herein. The singular forms “a,” “an,” and “the” include plural referents unless the context clearly dictates otherwise. Thus, for example, reference to an item includes reference to one or more items. The term “ones” refers to one, two, or more, and generally applies to the selection of some or all of a quantity. The term “plurality” refers to two or more of an item. The term “about” or “approximately” means that quantities, dimensions; sizes, formulations, parameters, shapes and other characteristics need not be exact, but may be approximated and/or larger or smaller, as desired, reflecting acceptable tolerances, conversion factors, rounding off, measurement error and the like and other factors known to those of skill in the art. The term “substantially” means that the recited characteristic, parameter, or value need not be achieved exactly, but that deviations or variations, including for example, tolerances, measurement error, measurement accuracy limitations and other factors known to those of skill in the art, may occur in amounts that do not preclude the effect the characteristic was intended to provide.

Numerical data may be expressed or presented herein in a range format. It is to be understood that such a range format is used merely for convenience and brevity and thus should be interpreted flexibly to include not only the numerical values explicitly recited as the limits of the range, but also interpreted to include all of the individual numerical values or sub-ranges encompassed within that range as if each numerical value and sub-range is explicitly recited. As an illustration, a numerical range of “about 1 to 5” should be interpreted to include not only the explicitly recited values of about 1 to about 5, but should also be interpreted to also include individual values and sub-ranges within the indicated range. Thus, included in this numerical range are individual values such as 2, 3 and 4 and sub-ranges such as “about 1 to about 3,” “about 2 to about 4” and “about 3 to about 5,” “1 to 3,” “2 to 4,” “3 to 5,” etc. This same principle applies to ranges reciting only one numerical value (e.g., “greater than about 1”) and should apply regardless of the breadth of the range or the characteristics being described. A plurality of items may be presented in a common list for convenience. However, these lists should be construed as though each member of the list is individually identified as a separate and unique member. Thus, no individual member of such list should be construed as a de facto equivalent of any other member of the same list solely based on their presentation in a common group without indications to the contrary. Furthermore, where the terms “and” and “or” are used in conjunction with a list of items, they are to be interpreted broadly, in that any one or more of the listed items may be used alone or in combination with other listed items. The term “alternatively” refers to selection of one of two or more alternatives, and is not intended to limit the selection to only those listed alternatives or to only one of the listed alternatives at a time, unless the context clearly indicates otherwise.

While exemplary embodiments are described above, it is not intended that these embodiments describe all possible forms encompassed by the claims. The words used in the specification are words of description rather than limitation, and it is understood that various changes can be made without departing from the spirit and scope of the disclosure. As previously described, the features of various embodiments can be combined to form further exemplary aspects of the present disclosure that may not be explicitly described or illustrated. While various embodiments could have been described as providing advantages or being preferred over other embodiments or prior art implementations with respect to one or more desired characteristics, those of ordinary skill in the art recognize that one or more features or characteristics can be compromised to achieve desired overall system attributes, which depend on the specific application and implementation. These attributes can include, but are not limited to cost, strength, durability, life cycle cost, marketability, appearance, packaging, size, serviceability, weight, manufacturability, ease of assembly, etc. As such, embodiments described as less desirable than other embodiments or prior art implementations with respect to one or more characteristics are not outside the scope of the disclosure and can be desirable for particular applications.

What is claimed is:

1. A tow hook assembly for a vehicle, comprising:
a tow hook, comprising
a first arm having a first end and a second end opposite the first end, the first end defining a first opening;
a second arm having a first end and a second end opposite the first end, the first end defining a second opening; and
a connecting portion having a first end and a second end, the second end of the first arm extending from the first end of the connecting portion and the second end of the second arm extending from the second end of the connecting portion such that the first arm, the second arm, and the connecting portion form a U-shaped member;
a bracket, comprising
a first leg having a first end and a second end opposite the first end, the first end defining a first opening;
a second leg having a first end and a second end opposite the first end, the first end defining a second opening; and
a body portion having a first side and a second side, the second end of the first leg extending from the first side of the body portion and the second end of the second leg extending from the second side of the body portion; and
a coupling member;
wherein the coupling member passes through the first and second openings of the first and second arms of the tow hook and the first and second openings of the first and second legs of the bracket such that the tow hook is pivotable between a first position and a second position relative to the bracket.

2. The tow hook assembly of claim 1, wherein the bracket further comprises a stop portion extending from the body portion and the stop portion limits rotation of the tow hook relative to the bracket.

3. The tow hook assembly of claim 1, wherein the bracket further comprises a first stop portion and a second stop portion, the first stop portion extending from the first side of the body portion and the second stop portion extending from the second side of the body portion, the first stop portion adjacent to the first arm of the tow hook and the second stop portion adjacent to the second arm of the tow hook such that the first and second stop portions limit rotation of the tow hook relative to the bracket.

4. The tow hook assembly of claim 1, wherein the coupling member is a bolt.

5. The tow hook assembly of claim 1, wherein the first position is a stowed position and the second position is an extended position.

6. An automotive vehicle, comprising:
a vehicle body, the vehicle body comprising a bumper including a bumper shell, an edge of the bumper shell defining an underbody opening;
a trailer hitch assembly, the trailer hitch assembly comprising a mounting member; and
a tow hook assembly coupled to the mounting member of the trailer hitch assembly, the tow hook assembly comprising a tow hook, a bracket, and a coupling member, the tow hook coupled to the bracket by the coupling member, the tow hook pivotable between a first position and a second position about the coupling member;
wherein the tow hook is contained within a horizontal dimension and a vertical dimension defined by the bumper shell when the tow hook is in both the first and the second positions.

7. The automotive vehicle of claim 6, wherein the bracket comprises a body portion, a first leg, and a second leg, the first leg extending from a first side of the body portion and the second leg extending from a second side of the body portion opposite the first side such that the first leg and the second leg are substantially parallel.

8. The automotive vehicle of claim 7, wherein the tow hook comprises a first arm, a second arm, and a connecting portion, the first arm extending from a first end of the connecting portion and the second leg extending from a second end of the connecting portion opposite the first end such that the first arm and the second arm are substantially parallel.

9. The automotive vehicle of claim 8, wherein the bracket further comprises at least one stop portion extending from the body portion, wherein the stop portion limits rotation of the tow hook relative to the bracket.

10. The automotive vehicle of claim 6, wherein the first position is a stowed position and the second position is an extended position.

11. A tow hook assembly for a vehicle, comprising:
a tow hook, a bracket, and a coupling member, the tow hook coupled to the bracket by the coupling member, the tow hook pivotable between a first position and a second position about the coupling member;
wherein the tow hook is contained within a horizontal dimension and a vertical dimension defined by a vehicle bumper when the tow hook is in both the first and the second positions.

12. The tow hook assembly of claim 11, wherein the tow hook further comprises a first arm and a second arm and a connecting portion connecting the first arm and the second arm such that the tow hook forms a U-shaped member.

13. The tow hook assembly of claim 11, wherein the bracket further comprises a body portion and a first leg and a second leg, the first leg and the second leg extending from opposite sides of the body portion.

14. The tow hook assembly of claim 13, wherein the bracket further comprises a stop portion extending from the body portion and the stop portion limits rotation of the tow hook relative to the bracket.

15. The tow hook assembly of claim 13, wherein the bracket further comprises a first stop portion and a second stop portion, the first stop portion extending from a first side of the body portion and the second stop portion extending from a second side of the body portion, the first stop portion adjacent to the first arm of the tow hook and the second stop portion adjacent to the second arm of the tow hook such that the first and second stop portions limit rotation of the tow hook relative to the bracket.

16. The tow hook assembly of claim 11, wherein the coupling member is a bolt.

17. The tow hook assembly of claim 11, wherein the first position is a stowed position and the second position is an extended position.
